(19) United States
(12) Patent Application Publication
(10) Pub. No.: US 2025/0117643 A1
(43) Pub. Date: Apr. 10, 2025

(54) USING STRUCTURED INFORMATION FOR IMPROVED TRAINING OF GENERATIVE ARTIFICIAL INTELLIGENCE (AI) MODELS

(71) Applicant: Bank of America Corporation, Charlotte, NC (US)

(72) Inventor: Maharaj Mukherjee, Poughkeepsie, NY (US)

(21) Appl. No.: 18/377,350

(22) Filed: Oct. 6, 2023

(51) Int. Cl. G06N 3/08

(52) U.S. Cl. CPC G06N 3/08

(57) ABSTRACT

A computing platform may obtain, from an information storage source, historical information, which may be structured rather than unstructured. The computing platform may train, using the historical information, a foundational artificial intelligence (AI) model. The computing platform may select one or more features of the foundational AI model for use in training a generative AI model. The computing platform may identify a portion of the historical information corresponding to the selected one or more features. The computing platform may normalize the portion of the historical information. The computing platform may train, using the normalized portion of the historical information, the generative AI model. The computing platform may receive, from a user device, a generative AI prompt. The computing platform may generate, by inputting the generative AI prompt into the generative AI model, a generative AI response. The computing platform may send, to the user device, the generative AI response.

### BACKGROUND

As the usage of generative artificial intelligence (AI) becomes increasingly prevalent, it is apparent that this new type of AI may be used for multiple different applications. In many instances, however, such generative AI models are trained completely on unstructured information. In some domains, most (or all) of the training and/or input information may be structured. Accordingly, training generative AI models for these domains using unstructured information may be inefficient and/or result in inaccurate models. It may be important to provide improved training for generative AI models in such domains.

### SUMMARY

Aspects of the disclosure provide effective, efficient, scalable, and convenient technical solutions that address and overcome the technical problems associated with the training and implementation of generative AI models. In one or more instances, a computing platform having at least one processor, a communication interface, and memory may obtain, from an information storage source, historical information, which may be structured rather than unstructured. The computing platform may train, using the historical information, a foundational artificial intelligence (AI) model. The computing platform may select one or more features of the foundational AI model for use in training a generative AI model. The computing platform may identify a portion of the historical information corresponding to the selected one or more features. The computing platform may normalize the portion of the historical information. The computing platform may train, using the normalized portion of the historical information, the generative AI model. The computing platform may receive, from a user device, a generative AI prompt. The computing platform may generate, by inputting the generative AI prompt into the generative AI model, a generative AI response. The computing platform may send, to the user device, the generative AI response.

In one or more instances, training the foundational AI model may include generating a multi-dimensional hyper-space using the historical information. In one or more instances, generating the multi-dimensional hyper-space may include using unsupervised learning to cluster the historical information.

In one or more examples, training the generative AI model may include clustering the normalized portion of the historical information to produce a corresponding heatmap within the multi-dimensional hyper-space. In one or more examples, training the generative AI model may include converting the normalized portion of the historical information to a frequency domain, and training, using the converted normalized portion of the historical information, a convolutional neural network.

In one or more instances, the convolutional neural network is hosted across a plurality of graphics processing units. In one or more instances, normalizing the portion of the historical information may include, for each element of the portion of the historical information: subtracting a minimum element value from a value of the given element to produce a first difference, subtracting the minimum element value from a maximum element value to produce a second difference, and dividing the first difference by the second difference.

In one or more examples, the computing platform may train, using a second portion of the historical information, a second generative AI model, where the generative AI model may be directed to a first domain and the second generative AI model may be directed to a second domain, different than the first domain. In one or more instances, a unique heatmap may be produced for each of the generative AI model and the second generative AI model within the multi-dimensional hyper-space.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A-1B depict an illustrative computing environment for using structured information for improved training of generative AI models in accordance with one or more example embodiments;

FIGS. 2A-2C depict an illustrative event sequence for using structured information for improved training of generative AI models in accordance with one or more example embodiments;

FIG. 3 depicts an illustrative method for using structured information for improved training of generative AI models in accordance with one or more example embodiments; and

FIG. 4 depicts an illustrative user interface for using structured information for improved training of generative AI models in accordance with one or more example embodiments.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. In some instances, other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

As a brief introduction of the concepts described in further detail below, systems and methods for using structured information for improved training of generative AI models are described herein. Recent advancements on chat bots using generative artificial intelligence (AI) have demonstrated the power of this new type of AI for multiple different applications. Unfortunately, the focus on creating generative AI is completely on unstructured data. In certain domains, most of the information is structured, and organizations within these domains may have a significant amount of information that is structured in nature.

Generative AI models may be created completely from scratch using structured information rather than retrofitting currently available generative AI developed for unstructured information for these use cases involving structured information.

The generative AI may start with building a generalized or foundational AI model with a massive amount of information covering almost anything and everything, and let it converge after unsupervised learning and/or convolutional neural networks (CNN) into an unspecified number of clusters. The foundational AI model may be further specialized into several generative AI models built on top of the foundational AI model. For example, further unsupervised or semi-supervised learning techniques may be used to cluster information of the foundational AI into specialized clusters. This method may include normalizing the structured information and creating thermal images/heatmaps in large dimensional hyper-spaces. Each heat map in the hyper-dimensional planes may be further divided by using unsupervised or semi-supervised models into specialized clusters.

Such specialized generative AI models may be used for specialized applications such as anti-money laundering, elder protection, fraud analysis, credit approval, loan approval, mortgage approval, and/or other applications. In some instances, this method may be implemented using either graphics processing units and/or massively distributed computing.

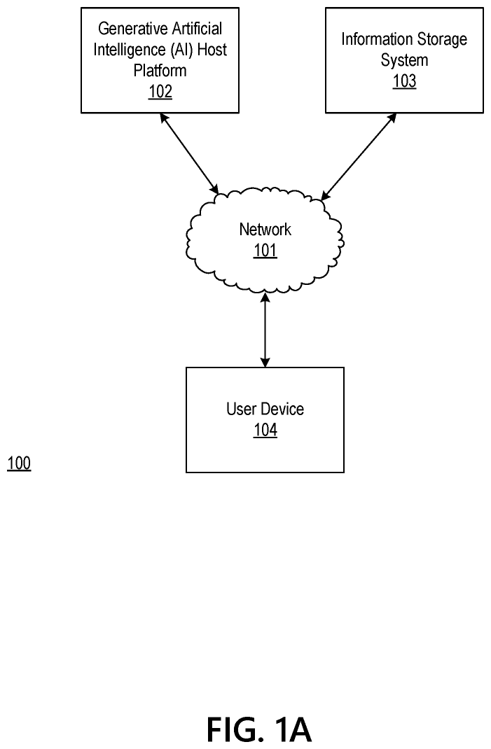

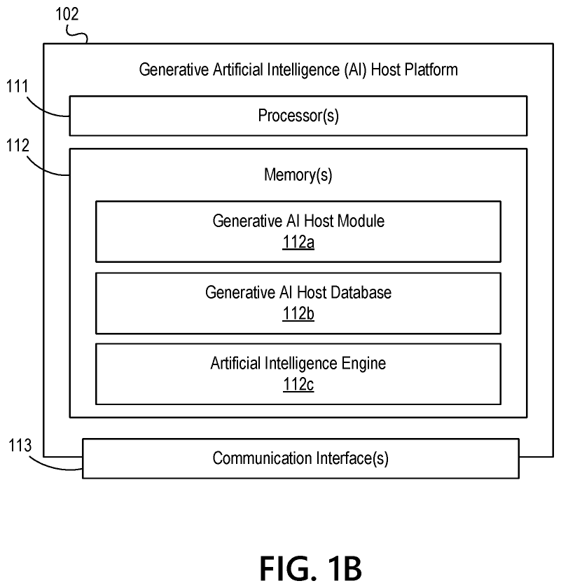

FIGS. 1A-1B depict an illustrative computing environment for using structured information for improved training of generative AI models in accordance with one or more example embodiments. Referring to FIG. 1A, computing environment 100 may include one or more computer systems. For example, computing environment 100 may include generative artificial intelligence (AI) host platform 102, information storage system 103, and user device 104.

As described further below, generative AI host platform 102 may be a computer system that includes one or more computing devices (e.g., servers, server blades, or the like) and/or other computer components (e.g., processors, memories, communication interfaces) that may be used to train, host, and/or otherwise maintain a foundational AI model and/or corresponding generative AI models. In some instances, the generative AI host platform 102 may train the foundational AI model and/or corresponding generative AI models using unsupervised learning and/or convolutional neural networks.

Information storage system 103 may be a computer system that includes one or more computing devices (e.g., servers, server blades, or the like) and/or other computer components (e.g., processors, memories, communication interfaces) that may be used to store structured information (e.g., rather than unstructured information). For example, the information storage system 103 may store information related to specialized applications such as anti-money laundering, elder protection, fraud analysis, credit approval, loan approval, mortgage approval, and/or other applications. In some instances, the information storage system 103 may be configured to communicate with the generative AI host platform 102.

User device 104 may be and/or otherwise include a laptop computer, desktop computer, mobile device, tablet, smartphone, and/or other device that may be used by an individual (e.g., to obtain responses from the generative AI models, or the like). In some instances, user device 104 may be configured to display one or more user interfaces (e.g., generative AI response interfaces, or the like).

Although a single administrator device and user device are shown, any number of such devices may be deployed in the systems/methods described below without departing from the scope of the disclosure.

Computing environment 100 also may include one or more networks, which may interconnect generative AI host platform 102, information storage system 103, user device 104, or the like. For example, computing environment 100 may include a network 101 (which may interconnect, e.g., generative AI host platform 102, information storage system 103, user device 104, or the like).

In one or more arrangements, generative AI host platform 102, information storage system 103, and user device 104 may be any type of computing device capable of sending and/or receiving requests and processing the requests accordingly. For example, generative AI host platform 102, information storage system 103, user device 104, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of generative AI host platform 102, information storage system 103, and/or user device 104 may, in some instances, be special-purpose computing devices configured to perform specific functions.

Referring to FIG. 1B, generative AI host platform 102 may include one or more processors 111, memory 112, and communication interface 113. A data bus may interconnect processor 111, memory 112, and communication interface 113. Communication interface 113 may be a network interface configured to support communication between generative AI host platform 102 and one or more networks (e.g., network 101, or the like). Memory 112 may include one or more program modules having instructions that when executed by processor 111 cause generative AI host platform 102 to perform one or more functions described herein and/or one or more databases that may store and/or otherwise maintain information which may be used by such program modules and/or processor 111. In some instances, the one or more program modules and/or databases may be stored by and/or maintained in different memory units of generative AI host platform 102 and/or by different computing devices that may form and/or otherwise make up generative AI host platform 102. For example, memory 112 may have, host, store, and/or include generative AI host module 112a, generative AI host database 112b, and/or artificial intelligence engine 112c.

Generative AI host module 112a may have instructions that direct and/or cause generative AI host platform 102 to train generative AI models using structured information, as discussed in greater detail below. Generative AI host database 112b may store information used by generative AI host module 112a and/or generative AI host platform 102 to train generative AI models using structured information, and/or in performing other functions. Artificial intelligence engine 112c may be configured to train, host, and/or otherwise maintain one or more generative AI models that may be used by generative AI host module 112a and/or generative AI host platform 102.

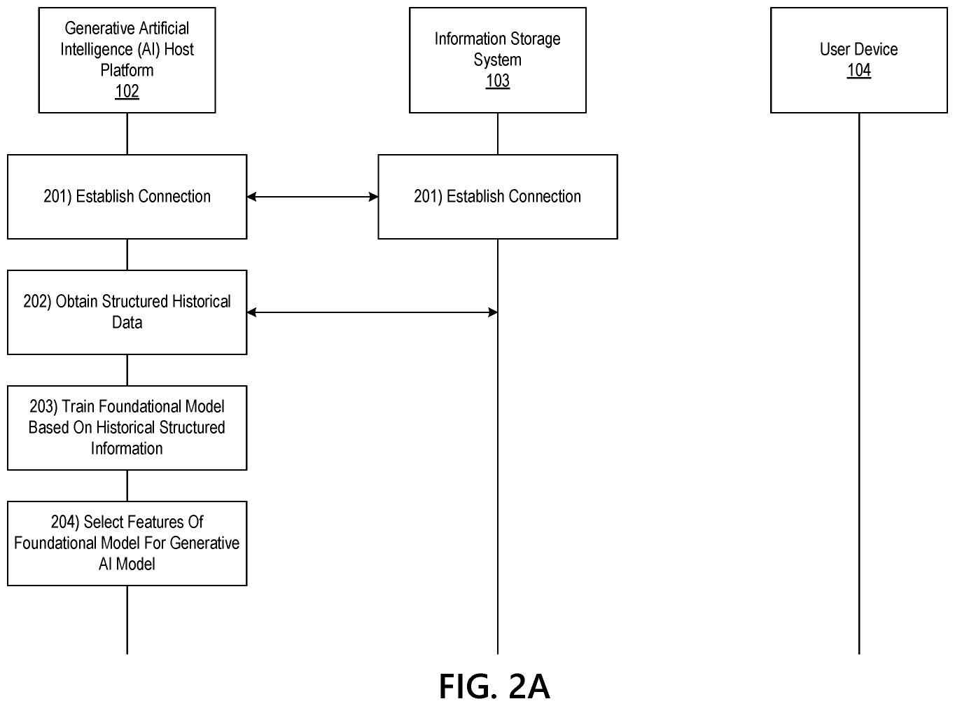

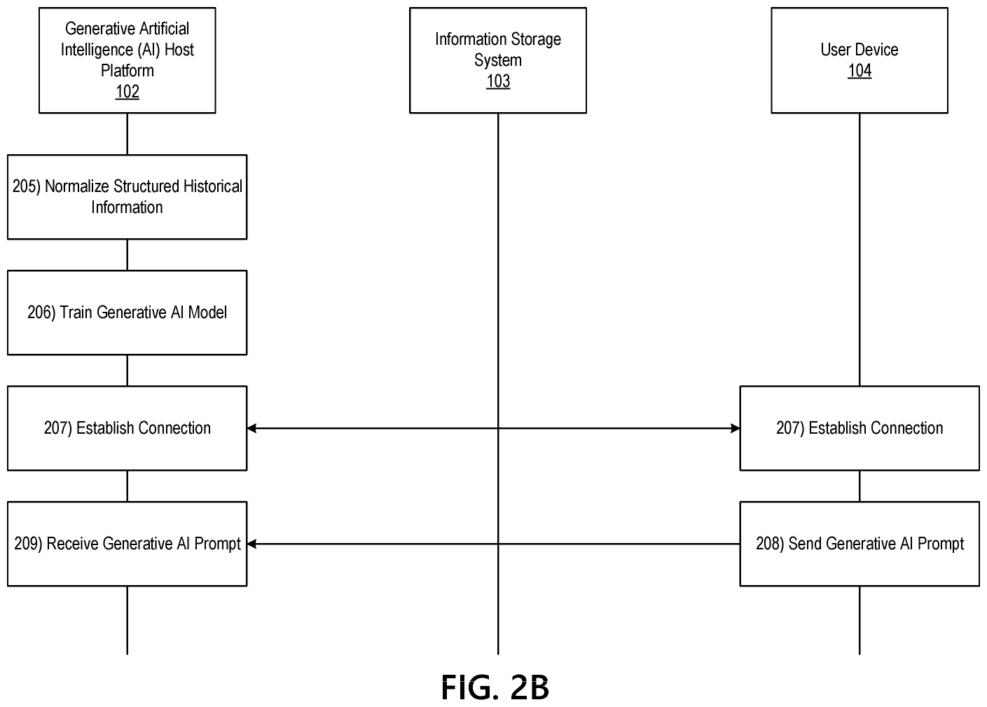

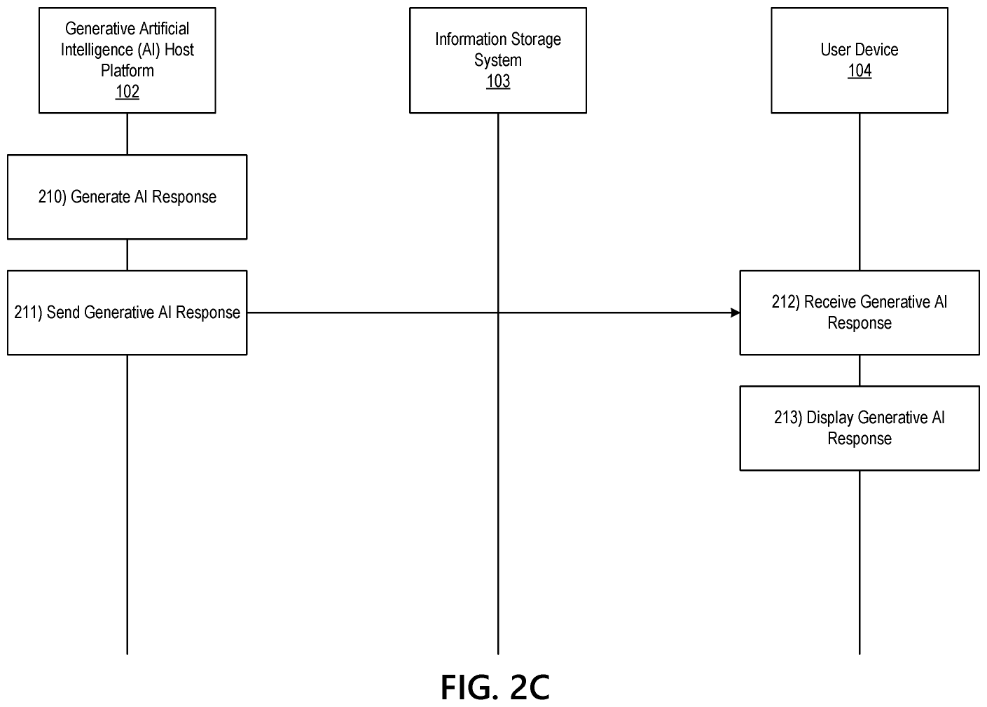

FIGS. 2A-2C depict an illustrative event sequence for using structured information for

improved training of generative AI models in accordance with one or more example embodiments. Referring to FIG. 2A, at step 201, the generative AI host platform 102 may establish a connection with the information storage system 103. For example, the generative AI host platform 102 may establish a first wireless data connection with the information storage system 103 to link the generative AI host platform 102 to the information storage system 103 (e.g., in preparation for obtaining structured historical information). In some instances, the generative AI host platform 102 may identify whether or not a connection is already established with the information storage system 103. If a connection is already established with the information storage system 103, the generative AI host platform 102 might not re-establish the connection. Otherwise, if the connection is not yet established with the information storage system 103, the generative AI host platform 102 may establish the first wireless data connection as described herein.

At step 202, the generative AI host platform 102 may obtain structured historical information from the information storage system 103 (e.g., in contrast to unstructured historical information). For example, the generative AI host platform 102 may request the structured historical information via the communication interface 113 and while the first wireless data connection is established, and the information storage system 103 may provide the unstructured historical information accordingly. For example, the generative AI host platform 102 may obtain information corresponding to specialized applications such as anti-money laundering, elder protection, fraud analysis, credit approval, loan approval, mortgage approval, and/or other applications.

At step 203, the generative AI host platform 102 may train a foundational AI model using the historical structured information. For example, the generative AI host platform 102 may train an AI model corresponding to a plurality of different domains (e.g., the domains of each of the generative AI models, which are described further below). In some instances, in training the foundational AI model, the generative AI host platform 102 may normalize the historical structured information to represent the historical structured information as values between zero and one. For example, the generative AI host platform may 102 may, for each piece of the historical structured information, subtract a minimum value of the historical structured information from the value of the corresponding piece of the historical structured information to identify a first difference. The generative AI host platform 102 may also subtract the minimum value of the historical structured information from a maximum value of the historical structured information to identify a second difference. The generative AI host platform 102 may then divide the first difference by the second difference to identify a normalized value for the corresponding piece of the historical structured information.

Once the generative AI host platform 102 has normalized the historical structured information, the generative AI host platform 102 may train the foundational AI model by using unsupervised learning to cluster the historical structured information. The generative AI host platform 102 may then generate a multi-dimensional hyper-space representative of the foundational AI model, where each feature (e.g., each type of information in the historical structured information) may correspond to a dimension of the multi-dimensional hyper-space. In these instances, the multi-dimensional hyper-space may correspond to a multi-dimensional thermal image and/or heatmap.

This normalization may be possible due to the structured nature of the historical information (and might otherwise not be possible with unstructured information). Such normalization of the historical information may enable the generation of the multi-dimensional hyperspace, heatmaps, and/or thermal images as described herein, which may e.g., improve accuracy of the specialized generative AI models. For example, this multi-dimensionality of these models may enable more efficient processing of generative AI prompts. Additionally, this may enable more accurate and computationally efficient response generation due to the quicker convergence of the specialized generative AI models (e.g., as compared to models trained on unstructured information). For example, because the features are defined, the models may be trained using fewer iterations, which may reduce a time to converge, and thus an amount of energy used in the training.

Additionally or alternatively, the generative AI host platform 102 may transform the historical structured information to a frequency domain, and this transformed historical structured information may be similarly normalized and/or otherwise fed into a convolutional neural network to train the foundational AI model accordingly. In some instances, the training, hosting, and/or other maintenance of the foundational AI model may be distributed across a plurality of graphics processing units (GPU) and/or other computing systems, which may, e.g., allow parallel processing to improve processing times and/or distribute load.

At step 204, the generative AI host platform 102 may select features of the foundational AI model for use in training a specialized generative AI model. For example, whereas the foundational AI model may include structured historical information for a plurality of different domains, the specialized AI model may be tailored to a particular domain and/or otherwise include structured historical information limited to that domain. In some instances, to select these features, the generative AI host platform 102 may identify features that may be relevant to the particular domain corresponding to the specialized generative AI model.

Referring to FIG. 2B, at step 205, the generative AI host platform 102 may normalize the structured historical information corresponding to the particular domain (e.g., corresponding to the features identified at step 204). For example, the generative AI host platform 102 may identify a portion of the structured historical information corresponding to the one or more features. In some instances, the generative AI host platform 102 may obtain the normalized structured historical information directly from the foundational AI model. In other instances, the generative AI host platform 102 may perform a similar process as described above at step 203 to normalize the structured historical information corresponding to the particular domain. As discussed above at step 203, such normalization may be possible due to the structured nature of the historical information (and might otherwise not be possible with unstructured information). Such normalization of the historical information may enable the generation of the multi-dimensional hyperspace, heatmaps, and/or thermal images as described herein, which may e.g., improve accuracy of the specialized generative AI models. For example, this multi-dimensionality of these models may enable more efficient processing of generative AI prompts. Additionally, this may enable more accurate and computationally efficient response generation due to the quicker convergence of the specialized generative AI models (e.g., as compared to models trained on unstructured information). For example, because the features are defined, the models may be trained using fewer iterations, which may reduce a time to converge, and thus an amount of energy used in the training.

At step 206, the generative AI host platform 102 may train the specialized generative AI model. For example, the generative AI host platform 102 may perform actions similar to those described above at step 203 with regard to the foundational AI model, but the training may be limited to the normalized structured historical information of the particular domain (e.g., limited to the features identified at step 204). In some instances, the generative AI host platform 102 may train the specialized generative AI model using unsupervised clustering (e.g., based on similarities between the normalized structured historical information), and/or may convert the structured historical information to a frequency domain, and train a convolutional neural network using the frequency domain information. In some instances, the generative AI host platform 102 may generate a multi-dimensional hyper-space corresponding to the specialized generative AI model, which may, e.g., be a thermal image and/or heatmap. In some instances, this multi-dimensional hyper-space, thermal image, and/or heatmap for the specialized generative AI model may be within the multi-dimensional hyperspace of the foundational AI model.

In some instances, the training, hosting, and/or other maintenance of the specialized generative AI model may be distributed across a plurality of graphics processing units (GPU) and/or other computing systems, which may, e.g., allow parallel processing to improve processing times and/or distribute load.

Although the training of a single specialized generative AI model is described, any number of specialized generative AI models may be trained without departing from the scope of the disclosure. For example, a first specialized generative AI model may be directed to a first domain and a second specialized generative AI model may be directed to a second domain, different than the first domain. In these instances, each of the different specialized generative AI models may have unique thermal images and/or heatmaps within the multi-dimensional hyper-space. For example, the dimensions of each specialized generative AI model may vary based on the features of the corresponding model.

At step 207, the user device 104 may establish a connection with the generative AI host platform 102. For example, the user device 104 may establish a second wireless data connection with the generative AI host platform 102 to link the user device 104 to the generative AI host platform 102 (e.g., in preparation for sending generative AI prompts). In some instances, the user device 104 may identify whether or not a connection is already established with the generative AI host platform 102. If a connection is already established with the generative AI host platform 102, the user device 104 might not re-establish the connection. If a connection is not yet established with the generative AI host platform 102, the user device 104 may establish the second wireless data connection as described herein.

At step 208, the user device 104 may send a generative AI prompt to the generative AI host platform 102. For example, the user device 104 may send a generative AI prompt directed to the particular domain of the specialized generative AI model. In some instances, the user device 104 may send the generative AI prompt to the generative AI host platform 102 while the second wireless data connection is established.

At step 209, generative AI host platform 102 may receive the generative AI prompt sent at step 208. For example, the generative AI host platform 102 may receive the generative AI prompt via the communication interface 113 and while the second wireless data connection is established.

Referring to FIG. 2C, at step 210, the generative AI host platform 102 may input the generative AI prompt into the specialized generative AI model to produce a generative AI response. At step 211, the generative AI host platform 102 may send the generative AI response to the user device 104. For example, the generative AI host platform 102 may send the generative AI response to the user device 104 via the communication interface 113 and while the second wireless data connection is established. In some instances, the generative AI host platform 102 may also send one or more commands directing the user device 104 to display the generative AI response.

At step 212, the user device 104 may receive the generative AI response sent at step 211. For example, the user device 104 may receive the generative AI response while the second wireless data connection is established. In some instances, the user device 104 may also receive the one or more commands directing the user device 104 to display the generative AI response.

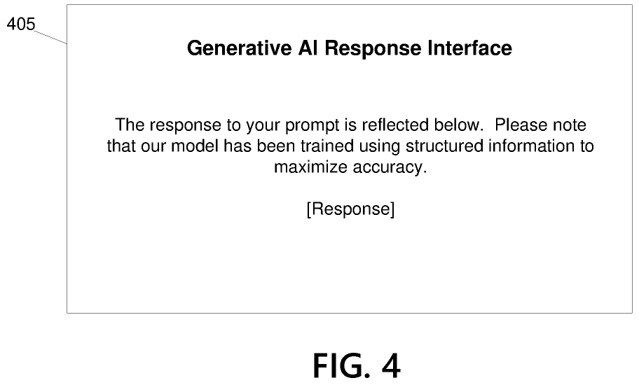

At step 213, based on or in response to the one or more commands directing the user device 104 to display the generative AI response, the user device 104 may display the generative AI response. For example, the user device 104 may display a graphical user interface similar to graphical user interface 405, which is shown in FIG. 4.

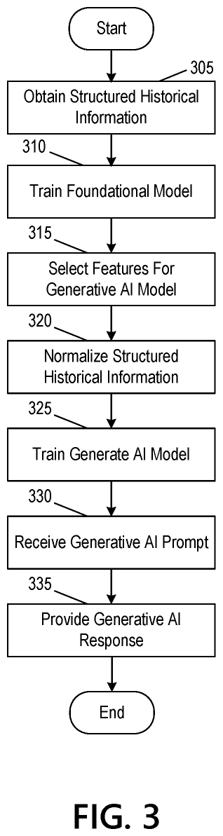

FIG. 3 depicts an illustrative method for using structured information for improved training of generative AI models in accordance with one or more example embodiments. At step 305, a computing platform having at least one processor, a communication interface, and memory may obtain structured historical information. At step 310, the computing platform may train a foundational AI model using the structured historical information. At step 315, the computing platform may select features for one or more specialized generative AI models. At step 320, the computing platform may normalize the structured historical information for each of the selected features. At step 325, the computing platform may train the specialized generative AI models using the normalized structured historical information associated with the features of each corresponding specialized generative AI models. At step 330, the computing platform may receive a generative AI prompt. At step 335, the computing platform may generate a generative AI response using one of the specialized generative AI models, and may provide the generative AI response to a user device.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform comprising:
at least one processor;
a communication interface communicatively coupled to the at least one processor; and
memory storing computer-readable instructions that, when executed by the at least one processor, cause the computing platform to:
obtain, from an information storage source, historical information, wherein the historical information is structured rather than unstructured;
train, using the historical information, a foundational artificial intelligence (AI) model;
select one or more features of the foundational AI model for use in training a generative AI model;
identify a portion of the historical information corresponding to the selected one or more features;
normalize the portion of the historical information;
train, using the normalized portion of the historical information, the generative AI model;
receive, from a user device, a generative AI prompt;
generate, by inputting the generative AI prompt into the generative AI model, a generative AI response; and
send, to the user device, the generative AI response.

2. The computing platform of claim 1, wherein training the foundational AI model comprises generating a multi-dimensional hyper-space using the historical information.

3. The computing platform of claim 2, wherein generating the multi-dimensional hyper-space comprises using unsupervised learning to cluster the historical information.

4. The computing platform of claim 2, wherein training the generative AI model comprises clustering the normalized portion of the historical information to produce a corresponding heatmap within the multi-dimensional hyper-space.

5. The computing platform of claim 1, wherein training the generative AI model comprises:
converting the normalized portion of the historical information to a frequency domain; and
training, using the converted normalized portion of the historical information, a convolutional neural network.

6. The computing platform of claim 5, wherein the convolutional neural network is hosted across a plurality of graphics processing units.

7. The computing platform of claim 1, wherein normalizing the portion of the historical information comprises, for each element of the portion of the historical information:
subtracting a minimum element value from a value of the given element to produce a first difference,
subtracting the minimum element value from a maximum element value to produce a second difference, and
dividing the first difference by the second difference.

8. The computing platform of claim 1, wherein the memory stores additional computer-readable instructions that, when executed by the at least one processor, further cause the computing platform to:
train, using a second portion of the historical information, a second generative AI model, wherein the generative AI model is directed to a first domain and the second generative AI model is directed to a second domain, different than the first domain.

9. The computing platform of claim 2, wherein a unique heatmap is produced for each of the generative AI model and the second generative AI model within the multi-dimensional hyper-space.

10. A method comprising:
at a computing platform comprising at least one processor, a communication interface, and memory:
obtaining, from an information storage source, historical information, wherein the historical information is structured rather than unstructured;
training, using the historical information, a foundational artificial intelligence (AI) model;
selecting one or more features of the foundational AI model for use in training a generative AI model;
identifying a portion of the historical information corresponding to the selected one or more features;
normalizing the portion of the historical information;
training, using the normalized portion of the historical information, the generative AI model;
receiving, from a user device, a generative AI prompt;
generating, by inputting the generative AI prompt into the generative AI model, a generative AI response; and
sending, to the user device, the generative AI response.

11. The method of claim 10, wherein training the foundational AI model comprises generating a multi-dimensional hyper-space using the historical information.

12. The method of claim 11, wherein generating the multi-dimensional hyper-space comprises using unsupervised learning to cluster the historical information.

13. The method of claim 11, wherein training the generative AI model comprises clustering the normalized portion of the historical information to produce a corresponding heatmap within the multi-dimensional hyper-space.

14. The method of claim 10, wherein training the generative AI model comprises:
converting the normalized portion of the historical information to a frequency domain; and
training, using the converted normalized portion of the historical information, a convolutional neural network.

15. The method of claim 14, wherein the convolutional neural network is hosted across a plurality of graphics processing units.

16. The method of claim 10, wherein normalizing the portion of the historical information comprises, for each element of the portion of the historical information:
subtracting a minimum element value from a value of the given element to produce a first difference,
subtracting the minimum element value from a maximum element value to produce a second difference, and
dividing the first difference by the second difference.

17. The method of claim 10, further comprising:
training, using a second portion of the historical information, a second generative AI model, wherein the generative AI model is directed to a first domain and the second generative AI model is directed to a second domain, different than the first domain.

18. The method of claim 11, wherein a unique heatmap is produced for each of the generative AI model and the second generative AI model within the multi-dimensional hyper-space.

19. One or more non-transitory computer-readable media storing instructions that, when executed by a computing platform comprising at least one processor, a communication interface, and memory, cause the computing platform to:
obtain, from an information storage source, historical information, wherein the historical information is structured rather than unstructured;
train, using the historical information, a foundational artificial intelligence (AI) model;
select one or more features of the foundational AI model for use in training a generative AI model;
identify a portion of the historical information corresponding to the selected one or more features;
normalize the portion of the historical information;
train, using the normalized portion of the historical information, the generative AI model;
receive, from a user device, a generative AI prompt;
generate, by inputting the generative AI prompt into the generative AI model, a generative AI response; and
send, to the user device, the generative AI response.

20. The one or more non-transitory computer-readable media of claim 19, wherein training the foundational AI model comprises generating a multi-dimensional hyper-space using the historical information.
